(19) United States
(12) Patent Application Publication
(10) Pub. No.: US 2020/0313517 A1
(43) Pub. Date: Oct. 1, 2020

(54) CIRCUIT SUBSTRATE AND ELECTRIC OIL PUMP

(71) Applicant: Nidec Tosok Corporation, Zama-shi (JP)

(72) Inventors: Yusaku SEKI, Zama-shi (JP); Chisato SEKIGUCHI, Zama-shi (JP); Junichi TAKAO, Zama-shi (JP); Yasuaki KONAGAYA, Zama-shi (JP)

(21) Appl. No.: 16/797,082

(22) Filed: Feb. 21, 2020

(30) Foreign Application Priority Data
Mar. 29, 2019 (JP) 2019-066641
Nov. 18, 2019 (JP) 2019-207887

(51) Int. Cl. H02K 11/26; H02H 9/04; H02K 7/14; H02K 11/00; H02K 11/33; H02K 11/40; F04B 17/03; F04B 15/02

(52) U.S. Cl. CPC H02K 11/26; H02H 9/046; H02K 7/14; H02K 11/0094; H02K 2211/03; H02K 11/40; F04B 17/03; F04B 15/02; H02K 11/33

(57) ABSTRACT

An electric oil pump includes a control substrate including a reverse connection protection circuit to protect a circuit in the substrate, a first substrate wiring connected to a source terminal of a MOSFET in the reverse connection protection circuit, a second substrate wiring connected to a GND terminal, and a bypass circuit that causes a current to flow from the first substrate wiring to the second substrate wiring in a case in which an output voltage of the external power supply is equal to or greater than a predetermined value that is greater than a rated voltage, in which the predetermined value is a value that is smaller than a withstanding voltage between a gate and the source of the MOSFET.

### CROSS REFERENCE TO RELATED APPLICATION

The present invention claims priority under 35 U.S.C. § 119 to Japanese Application No. 2019-066641 filed on Mar. 29, 2019 and Japanese Application No. 2019-207887 filed on Nov. 18, 2019, the entire contents of each of which are hereby incorporated herein by reference.

### FIELD

The present disclosure relates to a circuit substrate and an electric oil pump.

### BACKGROUND

In the related art, a circuit substrate that includes a substrate, a positive terminal to which a DC external power supply is input, a GND terminal, and a reverse connection protection circuit that protects a circuit in the substrate in a case in which positive and negative connection of the external power supply to the GND terminal is reversed is known.

For example, a circuit substrate described in Japanese Unexamined Patent Application Publication No. 2019-17128 includes a positive power supply terminal that serves as a positive terminal, a negative power supply terminal that serves as a GND terminal, and a reverse connection protection circuit. The reverse connection protection circuit includes a metal oxide semiconductor FET (MOSFET).

In the circuit substrate described in Japanese Unexamined Patent Application Publication No. 2019-17128, utilization of a high withstanding voltage MOSFET as a countermeasure is conceivable in a case in which an external power supply with a probability that the external power supply may generate a transient overvoltage (transient surge), for example, an instantaneous pulse of equal to or greater than double a rated voltage is connected. However, there is a problem that utilization of a high withstanding voltage MOSFET leads to an increase in costs.

### SUMMARY

Example embodiments of the present disclosure provide circuit substrates and electric oil pumps each capable of preventing breakage of a MOSFET due to an overvoltage at lower costs as compared with a case in which a high withstanding voltage MOSFET is used.

According to an example embodiment of the present disclosure, a circuit substrate includes a substrate, a positive terminal and a GND terminal to which a DC external power supply is input, a reverse connection protection circuit that protects a circuit in the substrate in a case in which positive and negative connection of the external power supply is reversed, the reverse connection protection circuit being a circuit substrate provided with a MOSFET, a first substrate wiring that is connected to a source terminal of the MOSFET, a second substrate wiring that is connected to the GND terminal, and a bypass circuit that causes a current to flow from the first substrate wiring to the second substrate wiring in a case in which an output voltage of the external power supply is equal to or greater than a predetermined value, in which the predetermined value is a value that is smaller than a withstanding voltage between a gate and the source of the MOSFET.

According to another example embodiment of the present disclosure, an electric oil pump includes a pump, a motor that drives the pump, and a circuit substrate, in which the circuit substrate includes a motor drive circuit that drives the motor, and the circuit substrate is the circuit substrate according to an example embodiment of the present disclosure.

According to an example embodiment of the present disclosure, an excellent effect that it is possible to prevent breakage of a MOSFET due to overvoltage is achieved at lower costs as compared with a case in which a high withstanding voltage MOSFET is used.

According to an example embodiment of the present disclosure, an excellent effect in that it is possible to drive the motor with an inexpensive circuit substrate that does not use a high withstanding voltage MOSFET in the reverse connection protection circuit is achieved in addition to the above-described effect.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view illustrating an electric oil pump according to an example embodiment of the present disclosure from a +Z side.

FIG. 2 is a perspective view illustrating the electric oil pump from a −Z side.

FIG. 3 is a sectional view illustrating an X-Z cut plane of the electric oil pump at a position of a center axis J.

FIG. 4 is an exploded perspective view illustrating portions of the electric oil pump except for a housing, a motor cover, a pump cover, and an inverter cover from a side to the rear in an axial direction.

FIG. 5 is a perspective view illustrating the motor, a portion of the inverter in the housing, and a rotation angle sensor from a side in front in the axial direction.

FIG. 6 is a block diagram of a circuit on a control substrate of the inverter in the electric oil pump.

FIG. 7 is a plan view illustrating a first surface of the control substrate.

FIG. 8 is a plan view illustrating a second surface of the control substrate.

FIG. 9 is a circuit diagram illustrating a portion of circuits on the control substrate.

FIG. 10 is a circuit diagram illustrating a portion of circuits on a control substrate of an electric oil pump according to a modification example.

### DETAILED DESCRIPTION

Hereinafter, electric oil pumps according to example embodiments of the present disclosure will be described with reference to drawings. In an example embodiment of the present disclosure, an electric oil pump that is mounted in a vehicle, such as a car, and supplies oil to a transmission will be described. Also, scales, numbers, and the like of the respective structures may be illustrated differently from those of actual structures in the following drawings for easy understanding of the respective components.

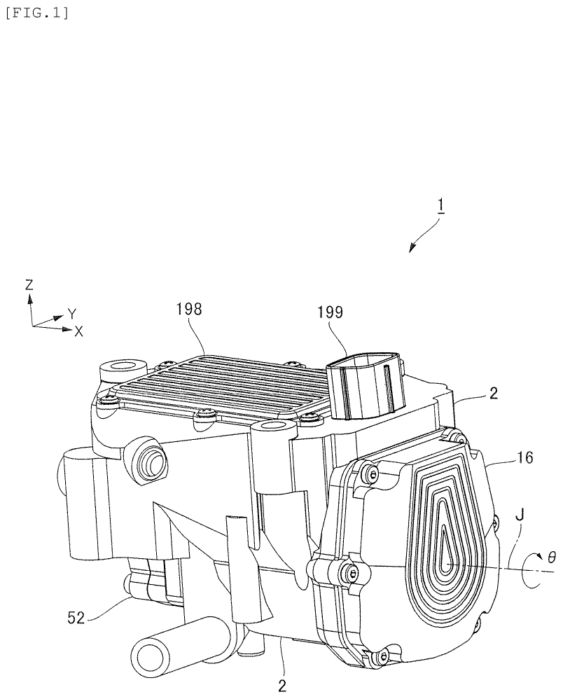

Also, XYZ coordinate systems will appropriately be illustrated as three-dimensional orthogonal coordinate systems in the drawings. In the XYZ coordinate systems, the X-axis direction is defined as a direction that is parallel to an axial direction of a center axis J illustrated in FIG. 1. The center axis J is a center axis line of a shaft (motor shaft) 13 of a motor unit 10, which will be described later. The Y-axis direction is defined as a direction that is parallel to a short side direction of an electric oil pump illustrated in FIG. 1. The Z-axis direction is defined as a direction that perpendicularly intersects both the X-axis direction and the Y-axis direction. In any of the X-axis direction, the Y-axis direction, and the Z-axis direction, the sides to which arrows illustrated in the drawings are directed are defined as + sides, and the opposite sides thereto are defined as − sides.

Also, in the following description, the positive side (+X side) in the X-axis direction will be referred to as a “rear side”, and the negative side (−X side) in the X-axis direction will be referred to as a “front side”. Note that the rear side and the front side are names used only for explanation and do not limit actual positional relationships and directions. The front side (−X side) corresponds to one side in the present disclosure, and the rear side (+X side) corresponds to the other side in the present disclosure. A direction (X-axis direction) that is parallel to the center axis J will simply be referred to as an “axial direction”, a radial direction from the center axis J will simply be referred to as a “radial direction”, and a circumferential direction around the center axis J, that is, around the center axis J (□ direction) will simply be referred to as a “circumferential direction” unless particularly indicated otherwise.

Note that in the specification, extending in the axial direction includes a case of extending strictly in the axial direction (X-axis direction) and also a case of extending in a direction inclined within a range of less than 45□ with respect to the axial direction. Also, in the specification, extending in the radial direction includes a case of extending strictly in the radial direction, that is, a direction that is perpendicular to the axial direction (X-axis direction) and also a case of extending in a direction inclined within a range of less than 45□ with respect to the radial direction.

### [Example Embodiment]

### <Overall Configuration>

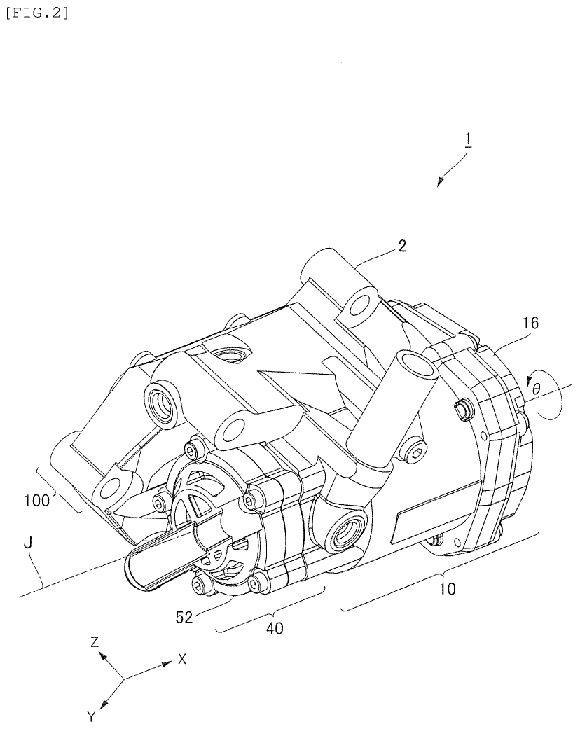

FIG. 1 is a perspective view illustrating an electric oil pump 1 according to an example embodiment from the +Z side. FIG. 2 is a perspective view illustrating the electric oil pump 1 from the −Z side. The electric oil pump 1 includes a housing 2, a motor unit 10, a pump unit 40, and an inverter 100 as illustrated in FIG. 2.

### (Housing 2)

The housing 2 is a cast product made of metal (aluminum, for example). The housing 2 serves as a motor housing of the motor unit 10, a pump housing of the pump unit 40, and an inverter housing of the inverter 100 at the same time. The motor housing of the motor unit 10, the pump housing of the pump unit 40, and the inverter housing of the inverter 100 are parts of a single member.

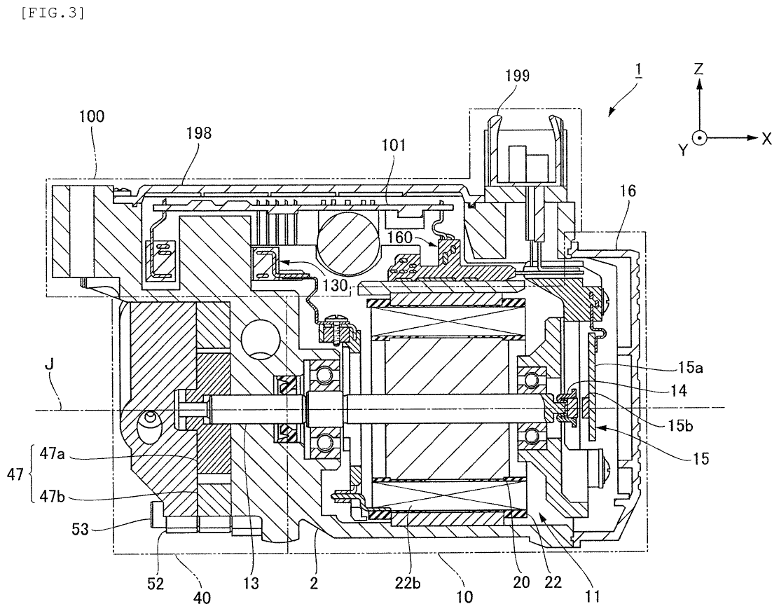

A rotor accommodation unit that accommodates a pump rotor (47 in FIG. 3) of the pump unit 40 and the motor housing of the motor unit 10 may be parts of a single member or may be separate elements. Also, the motor housing of the motor unit 10 and the pump housing of the pump unit 40 may be separate elements.

In a case in which the motor housing and the pump housing are parts of a single member as in the electric oil pump 1 according to the example embodiment, a boundary between the motor housing and the pump housing in the axial direction is defined as follows. In other words, a center of a wall, in which a through-hole for allowing the shaft (13 in FIG. 3) to penetrate therethrough from the inside of the motor housing toward the rotor accommodation unit of the pump housing is provided, in the axial direction is the boundary between both the housings in the axial direction.

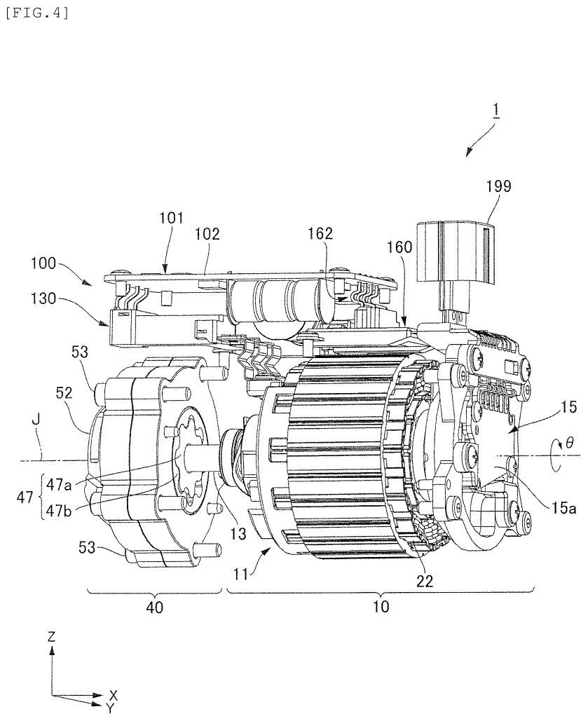

FIG. 3 is a sectional view illustrating an X-Z cut plane of the electric oil pump 1 at a position of the center axis J. FIG. 4 is an exploded perspective view illustrating portions of the electric oil pump 1 except for a housing (2 in FIG. 1), a motor cover (16 in FIG. 1), a pump cover (52 in FIG. 1), and an inverter cover (198 in FIG. 1) from the side to the rear in the axial direction.

### <Motor Unit 10>

The motor unit 10 includes a motor 11 in the motor housing.

### (Motor 11)

The motor 11 includes a shaft 13 disposed along the center axis J extending in the axial direction, a sensor magnet 14, a rotation angle sensor 15, a motor cover 16, a rotor 20, and a stator 22. The sensor magnet 14, the motor cover 16, and the rotor 20 are illustrated only in FIG. 3 out of FIGS. 3 and 4.

The motor 11 is an inner rotor-type motor, for example, the rotor 20 is secured to an outer circumferential surface of the shaft 13, and the stator 22 is disposed outward in the radial direction relative to the rotor 20. A part of the motor 11 except for the shaft 13 is a main body of the motor 11. In other words, the main body of the motor 11 is configured of the rotor 20, the stator 22, the sensor magnet 14, the rotation angle sensor 15, the motor cover 16, and the like.

The rotor 20 is secured to a region on the side to the rear (the other side) of the center of the axial direction of the shaft 13 and on the side in front (on one side) of an end on the rear side. The stator 22 is disposed such that an inner circumferential surface thereof is caused to face an outer circumferential surface of the rotor 20.

The shaft 13 that serves as a motor shaft projects from an end of the stator 22 on the front side and is then connected to the pump unit 40 (more specifically, a pump rotor 47, which will be described later) on the front side in the axial direction.

The stator 22 includes a coil 22b. If electricity is distributed to the coil 22b, then the rotor 20 rotates along with the shaft 13.

The sensor magnet 14 is secured to an end of the shaft 13 on the rear side in the axial direction as illustrated in FIG. 3 and rotates along with the shaft 13. A magnetic pole of one region of a disk-shaped sensor magnet 14 divided into two parts at a position of a diameter is an S pole, and a magnetic pole of the other region is an N pole.

The rotation angle sensor 15 is secured to an end of the motor 11 on the rear side. Also, the rotation angle sensor 15 includes a sensor substrate 15a and a Hall IC 15b mounted on the sensor substrate 15a. The sensor substrate 15a is disposed in a posture in which the substrate surface of the sensor substrate 15a follows the radial direction. The Hall IC 15b includes three Hall elements aligned in the circumferential direction, which are not illustrated in the drawing, and faces the sensor magnet 14 in the axial direction. If the sensor magnet 14 rotates along with the shaft 13, magnetic forces of the S pole and the N pole respectively detected by the three Hall element of the Hall IC 15b individually change. The three Hall elements respectively output Hall signals in accordance with the detected magnetic forces. A microcomputer of the inverter 100 identifies a rotation angle of the shaft 13 on the basis of a first Hall signal H1, a second Hall signal H2, and a third Hall signal H3 sent from the Hall IC 15b.

The housing 2 includes an opening, which is directed to the side to the rear in the axial direction, at an end on the rear side in the axial direction. The motor cover 16 is secured to the housing 2 and blocks the aforementioned opening. An operator can access the rotation angle sensor 15 of the motor 11 by detaching the motor cover 16 from the housing 2.

### <Pump Unit 40>

The pump unit 40 is located on the front side of the motor unit 10 in the axial direction as illustrated in FIG. 4 and is driven by the motor unit 10 via the shaft 13 to eject oil. The pump unit 40 includes a pump rotor 47 and a pump cover 52.

### (Pump Rotor 47)

The pump rotor 47 is attached to the shaft 13 on the front side. The pump rotor 47 includes an inner rotor 47a and an outer rotor 47b. The inner rotor 47a is secured to the shaft 13. The outer rotor 47b surrounds the outside of the inner rotor 47a in the radial direction.

The inner rotor 47a has an annular shape. The inner rotor 47a is a gear that has teeth on an outer side surface in the radial direction. The inner rotor 47a rotates about the axis (□ direction) along with the shaft 13. The outer rotor 47b has an annular shape surrounding the outside of the inner rotor 47a in the radial direction. The outer rotor 47b is a gear that has teeth on an inner side surface in the radial direction. An outer side surface of the outer rotor 47b in the radial direction has a circular shape.

The gear on the outer side surface of the inner rotor 47a in the radial direction and the gear on the inner side surface of the outer rotor 47b in the radial direction are engaged with each other, and the outer rotor 47b is rotated by the inner rotor 47a rotating with the rotation of the shaft 13. In other words, the pump rotor 47 rotates with the rotation of the shaft 13. The motor unit 10 and the pump unit 40 include the shaft 13 that serves as a rotation shaft made of the same member. In this manner, it is possible to curb an increase in size of the electric oil pump 1 in the axial direction.

Also, a volume between the engaged parts of the inner rotor 47a and the outer rotor 47b changes due to the inner rotor 47a and the outer rotor 47b rotating. A region with a reduced volume serves as a pressurization region, and a region with an increased volume serves as a negative pressure region.

### (Pump Cover 52)

The housing 2 includes an opening, which is directed to the side in front in the axial direction, at an end on the front side in the axial direction. The opening is closed with the pump cover 52. The pump cover 52 is secured to the housing 2 with a bolt 53.

### <Inverter 100>

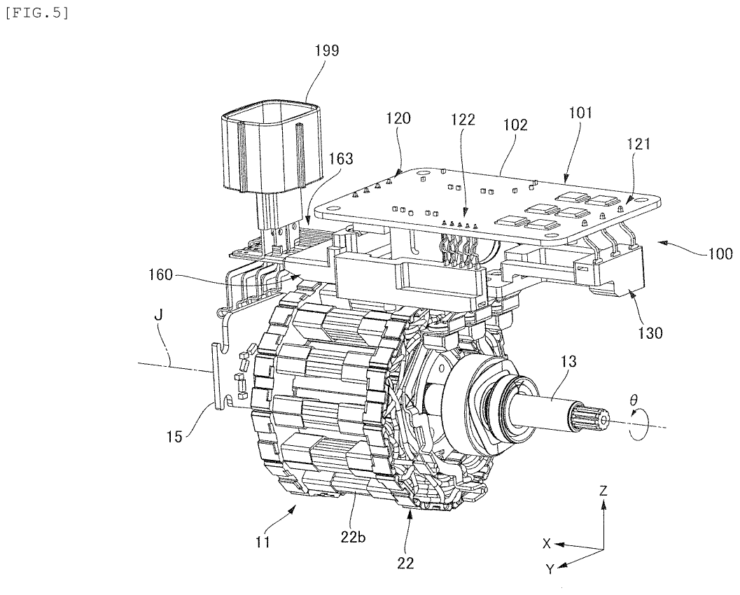

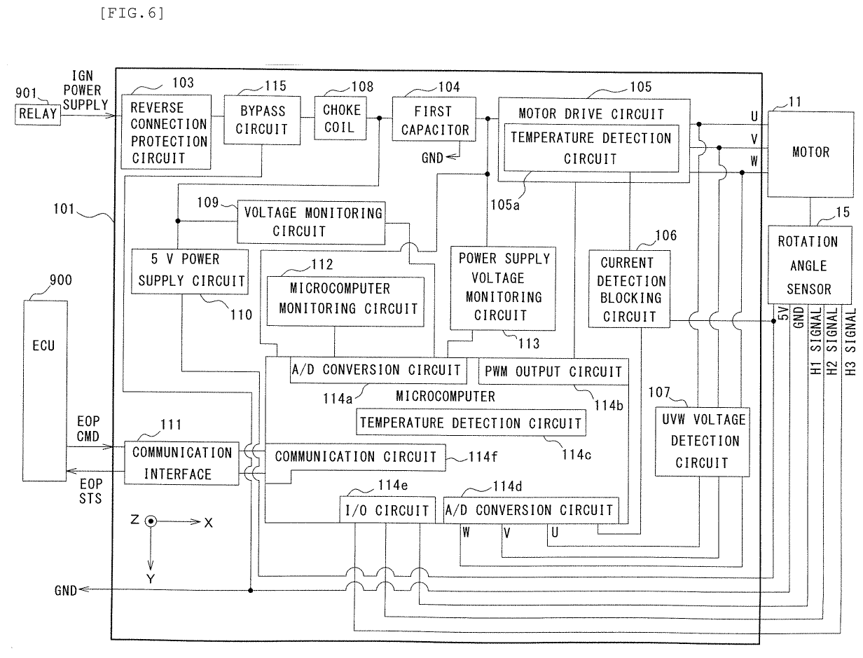

The inverter 100 is disposed on the +Z side in the Z-axis direction of the motor unit 10 and the pump unit 40. FIG. 5 is a perspective view illustrating the motor 11, a portion inside the housing (2 in FIG. 2) of the inverter 100, and the rotation angle sensor 15 from the side in front in the axial direction. In the drawing, illustration of a cylindrical core-back (22a in FIG. 6) of the stator 22 in the motor 11 is omitted for convenience. The inverter 100 that controls driving of the motor unit 10 includes a control substrate 101, a first wiring unit 130, a second wiring unit 160, and a connector 199.

### (Control Substrate 101)

The control substrate 101 includes a substrate 102 and a plurality of electronic component mounted on the substrate 102. Some of the plurality of electronic components configure a motor drive circuit that includes an inverter function. The substrate 102 includes a sensor connection unit 122 that is electrically connected to the respective wirings extending from the rotation angle sensor 15, a power supply input unit 120, and a motor power supply output unit 121.

The control substrate 101 is disposed further outward than the motor unit 10 in the radial direction in a posture in which any one of both surfaces of the control substrate 101 is caused to follow the axial direction. Since a first surface and a second surface of the control substrate 101 are parallel to each other, the control substrate 101 illustrated in the drawing is disposed in a posture in which both the surfaces are caused to follow the axial direction. The rotation angle sensor 15 is disposed on the side to the rear (+X side) in the axial direction of the control substrate 101.

### (First Wiring Unit 130)

The first wiring unit 130 plays a role of electrically connecting the respective bus bars (a U-phase bus bar, a V-phase bus bar, and a W-phase bus bar) of the motor 11 and the motor power supply output unit 121 of the substrate 102. The second wiring unit 160 plays a role of electrically connecting the respective terminals of the connector 199 and the power supply input unit 120 of the substrate 102 and also plays a role of electrically connecting the rotation angle sensor 15 of the motor 11 to the sensor connection unit 122 of the substrate 102. The first wiring unit 130 is disposed between the first surface of the substrate 102 and the pump unit 40 as illustrated in FIG. 4.

### (Connector 199)

The connector 199 is connected to an external ignition power supply connector. The ignition power supply connector includes four ports for a regular power supply, a GND, a CAN-Lo signal, and a CAN-Hi signal, is moved by the operator from the +Z side to the −Z side in the Z-axis direction, and is attached to the connector 199. The connector 199 includes four connector terminals that are individually electrically connected to the four ports of the ignition power supply.

### (Second Wiring Unit 160)

The second wiring unit 160 holds four power supply input wirings (162 in FIG. 4) and five sensor wirings (163 in FIG. 5) with a wiring holding member. Each of a connector terminal for the regular power supply, a connector terminal for the GND, a connector terminal for the CAN-Lo signal, and a connector terminal for the CAN-Hi signal of the connector 199 is soldered or welded to any of the four power supply input wirings.

Ends of the four respective power supply input wirings on the front side in the axial direction are folded toward the +Z side in the Z-axis direction, are inserted into the through-holes in the power supply input unit 120 on the substrate 102 and are soldered. Through the aforementioned soldering, the four power supply input wirings electrically connect the connector terminals of the connector 199 to the power supply input unit of the control substrate 101.

In FIG. 4, the sensor substrate 15a of the rotation angle sensor 15 is provided with five sensor terminals. Specifically, the sensor substrate 15a includes a sensor terminal that outputs the first Hall signal H1, a sensor terminal that is connected to the GND, a sensor terminal that outputs the second Hall signal H2, a sensor terminal that outputs a third Hall signal H3, and a sensor terminal that is electrically connected to a 5 V power supply.

Each of the five sensor terminals is connected to any of the five sensor wirings of the second wiring unit 160 through welding or soldering. The five sensor wirings electrically connect the rotation angle sensor 15 to the sensor connection unit 122 of the substrate 102 on the control substrate 101.

FIG. 6 is a block diagram of a circuit on the control substrate 101 for the inverter 100. The control substrate 101 includes a reverse connection protection circuit 103, a first capacitor 104, a motor drive circuit 105, a current detection blocking circuit 106, a U/V/W voltage detection circuit 107, a choke coil 108, and a voltage monitoring circuit 109. Also, the control substrate 101 includes a 5 V power supply circuit 110, a communication interface 111, a microcomputer monitoring circuit 112, a power supply voltage monitoring circuit 113, a microcomputer 114, and a bypass circuit 115.

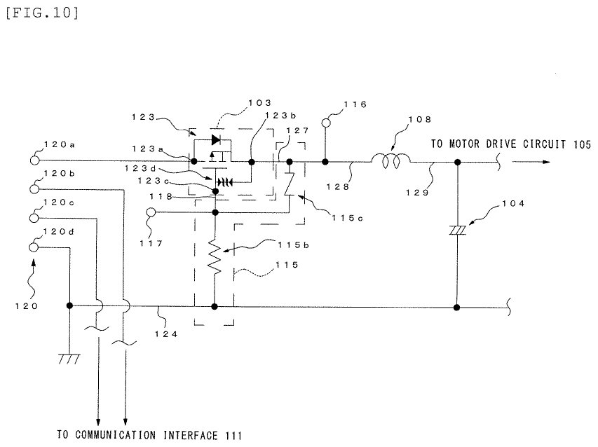

An ignition (IGN) power supply is connected to the power supply input unit (120 in FIG. 10) of the substrate 102 on the control substrate 101 via a relay 901 of the vehicle. The regular power supply of the ignition power supply and the GND are connected to the motor drive circuit 105 via the reverse connection protection circuit 103 and the first capacitor 104.

The reverse connection protection circuit 103 is a circuit that blocks an output of a negative voltage to the side downstream of the reverse connection protection circuit 103 in a case in which the regular power supply of the ignition power supply and the GND are connected in a reverse manner.

The first capacitor 104 is an electrolytic capacitor that absorbs a ripple current of the regular power supply (positive power supply) of the ignition power supply and stabilizes the voltage of the regular power supply.

The power supply voltage monitoring circuit 113 is connected to a substrate wiring that electrically connects the first capacitor 104 and the motor drive circuit 105. The power supply voltage monitoring circuit 113 detects a DC voltage output to the motor drive circuit 105 and outputs a detection value to an A/D conversion circuit 114a of the microcomputer 114.

The microcomputer 114 includes an A/D conversion circuit 114a, a PWM output circuit 114b, a temperature detection circuit 114c, an A/D conversion circuit 114d, an I/O circuit 114e, and a communication circuit 114f. The microcomputer 114 receives, using the communication circuit 114f, a control signal sent from an ECU 900 of the vehicle via the communication interface 111 of the control substrate 101 and generates a PWM signal for driving and rotating the motor 11 at a frequency based on the control signal. The generated PWM signal is output from the PWM output circuit 114b of the microcomputer 114 and is input to the motor drive circuit 105.

The motor drive circuit 105 converts a DC power supply sent from the first capacitor 104 into a three-phase AC power supply at a frequency in accordance with the PWM signal sent from the PWM output circuit 114b of the microcomputer 114 and outputs the three-phase AC power supply to the motor 11. The motor drive circuit 105 includes a plurality of bipolar transistors (MOSFETs) for switching and a temperature detection circuit 105a. The temperature detection circuit 105a of the motor drive circuit 105 outputs a temperature detection value to the current detection blocking circuit 106.

The current detection blocking circuit 106 detects a current flowing from the motor drive circuit 105 to the motor 11. The current detection blocking circuit 106 outputs a blocking signal to the microcomputer 114 if the detected current value exceeds a predetermined upper limit or the temperature detection value sent from the temperature detection circuit 105a of the motor drive circuit 105.

The microcomputer 114 stops generation of the PWM signal to stop driving of the motor 11 if the blocking signal is sent from the current detection blocking circuit 106 or if the temperature detection value obtained by the temperature detection circuit 114c of the microcomputer 114 exceeds the predetermined upper limit.

The U/V/W voltage detection circuit 107 detects a voltage of the three-phase AC power supply output from the motor drive circuit 105 to the motor 11 and outputs a detection value to the A/D conversion circuit 114d of the microcomputer 114.

The 5 V power supply circuit 110 is connected to a substrate wiring that electrically connects the reverse connection protection circuit 103 to the first capacitor 104 via the choke coil 108. The choke coil 108 configures a circuit that prevents a current flowing through the 5 V power supply circuit 110 from becoming an overcurrent. The 5 V power supply circuit 110 outputs a 5 V power supply to the rotation angle sensor 15.

The microcomputer monitoring circuit 112 is connected to the microcomputer 114 and monitors whether there is any abnormality in the microcomputer 114 through communication with the microcomputer 114.

The voltage monitoring circuit 109 detects a voltage of a DC power supply sent from the choke coil 108 to the 5 V power supply circuit 110 and outputs a detection value to the A/D conversion circuit 114a of the microcomputer 114.

The first Hall signal H1, the second Hall signal H2, and the third Hall signal output from the rotation angle sensor 15 are input to the I/O circuit 114e of the microcomputer 114. The microcomputer 114 identifies a rotation angle of the rotor (20 in FIG. 3) of the motor 11 on the basis of the first Hall signal H1, the second Hall signal H2, and the third Hall signal H3 and calculates a rotation frequency of the rotor on the basis of a result of the identification.

Note that a role of the bypass circuit 115 will be described later.

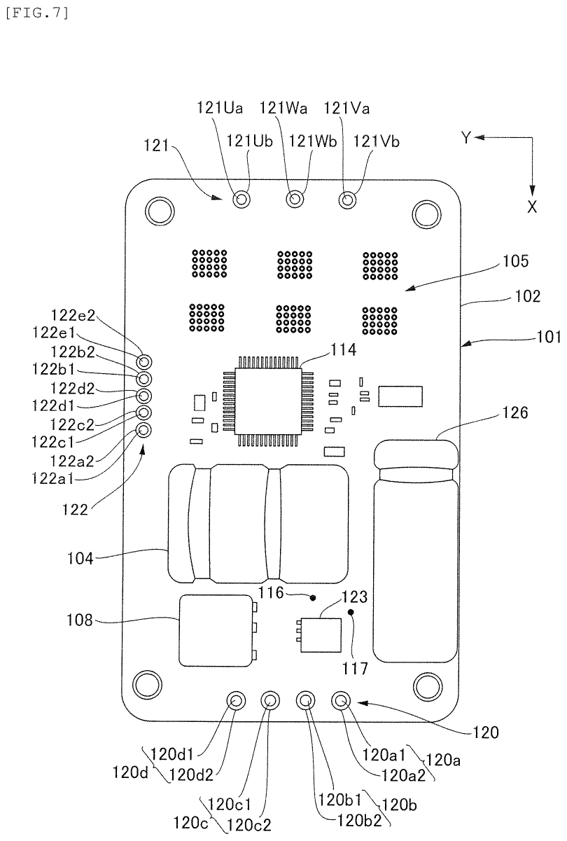

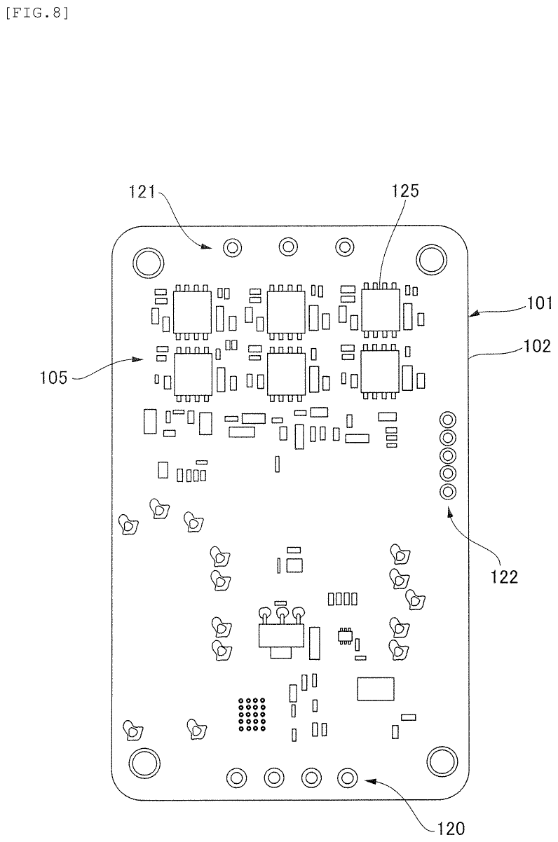

FIG. 7 is a plan view illustrating the first surface of the control substrate 101. FIG. 8 is a plan view illustrating the second surface of the control substrate 101. The power supply input unit 120 disposed at an end of the substrate 102 of the control substrate 101 on the side to the rear (+X side) in the axial direction includes four terminals including through-holes and lands. The first terminal is a positive terminal 120a that includes a through-hole 120a1 and a land 120a2 for the regular power supply. The second terminal is a Lo terminal that includes a through-hole 120b1 and a land 120b2 for the CAN-Lo signal. The third terminal is an Hi terminal that includes a through-hole 120c1 and a land 120c2 for the CAN-Hi signal. The fourth terminal is a GND terminal that includes a through-hole 120d1 and a land 120d2 for the GND. All of the aforementioned four terminals are individually electrically connected to the respective four connector terminals of the connector (199 in FIG. 10).

The choke coil 108 is mounted in a region on the side to the rear (−X side) of the power supply input unit 120 and on the side in front (+X side) of the first capacitor 104 on the substrate 102 in the axial direction. Also, the MOSFET 123 that configures the reverse connection protection circuit (103 in FIG. 12) is also mounted in the aforementioned region.

A second capacitor 126 is mounted on the −Y side of the first capacitor 104 and the MOSFET 123 in the Y-axis direction. The second capacitor 126 is an electrolytic capacitor for maintaining a power supply voltage at the time of instantaneous disconnection of the power supply.

The sensor connection unit 122 is provided and the microcomputer 114 is mounted in a region on the side to the rear of the second capacitor 126 and the first capacitor 104 on the substrate 102 in the axial direction. The sensor connection unit 122 includes five sets of through-holes and lands. The first set is a set of a through-hole 122a1 and a land 122a2 for the first Hall signal H1. The second set is a set of a through-hole 122c1 and a land 122c2 for the second Hall signal H2. The third set is a set of a through-hole 122d1 and a land 122d2 for the third Hall signal H3. The fourth set is a set of a through-hole 122b1 and a land 122b2 for the GND. The fifth set is a set of a through-hole 122e1 and a land 122e2 for the 5 V power supply. The aforementioned five sets are mutually aligned in the axial direction at an end of the substrate 102 in the Y-axis direction.

Six bipolar transistors 125 are mounted in a region on the side to the rear of the microcomputer 114 and the sensor connection unit 122 on the substrate 102 in the axial direction. The aforementioned six bipolar transistors 125 configure a part of the motor drive circuit 105.

A region on the side to the rear of the six bipolar transistors 125 in the axial direction on the substrate 102 corresponds to the end of the substrate 102 on the rear side. The motor power supply output unit 121 is disposed at the end on the rear side. The motor power supply output unit 121 includes three sets of through-holes and lands. The first set is a set of a through-hole 121Ua and a land 121Ub for the U phase of the three-phase AC power supply. The second set is a set of a through-hole 121Va and a land 121Vb for the V phase. The third set is a set of a through-hole 121Wa and a land 121Wb for the W phase. The aforementioned respective three sets output power supplies of mutually different phases.

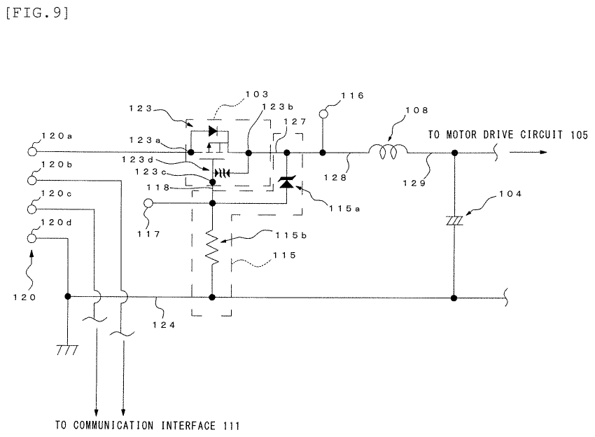

FIG. 9 is a circuit diagram illustrating a part of circuits on the control substrate 101 that serves as a circuit substrate. As illustrated in the drawing, the reverse connection protection circuit 103 includes the MOSFET 123. If a voltage is applied between the positive terminal of the ignition power supply and the GND terminal, then a voltage is applied between the source terminal 123b and the gate terminal 123c of the MOSFET 123. As illustrated in the drawing, a parasite diode that allows a flow of a current from the left side to the right side in the drawing is present in the MOSFET 123. If positive and negative connection of the ignition power supply is reversed, then the MOSFET 123 is not turned on and an output of a negative voltage to a side downstream of the reverse connection protection circuit 103 is blocked. In this manner, each circuit in the substrate 102 is protected.

The substrate 102 includes a first substrate wiring 127 that is connected to the source terminal 123b of the MOSFET 123, a second substrate wiring 124 connected to the GND terminal 120d, and the bypass circuit 115. The bypass circuit 115 is a circuit that causes a current to flow from the first substrate wiring 127 toward the second substrate wiring 124 in a case in which an output voltage of the ignition power supply that serves as an external power supply is equal to or greater than a predetermined value that is greater than a rated voltage (for example, 12 V). The aforementioned predetermined value (hereinafter, also referred to as a bypass opening value) is a value that is smaller than a withstanding voltage between the gate and the source of the MOSFET 123. In one example, the rated voltage of the ignition power supply is 12 [V], the withstanding voltage between the gate and the source of the MOSFET 123 is 20 [V], the withstanding voltage between a drain (123a) and the source of the MOSFET 123 is 40 [V], and the bypass opening value is 16 [V]. Although the configuration of the control substrate 101 will be described below using the aforementioned example, a combination of the rated voltage of the ignition power supply, the withstanding voltage between the gate and the source of the MOSFET 123, the withstanding voltage between the drain and the source of the MOSFET 123, and the bypass opening value is not limited to the aforementioned example. However, the MOSFET 123 is typically designed such that the withstanding voltage between the drain and the source is a value that is higher than the withstanding voltage between the gate and the source. Therefore, it is rare for the output voltage from the ignition power supply to exceed the withstanding voltage between the drain and the source and lead to breakage in terms of breakage of the MOSFET 123 due to an overvoltage. The output voltage from the ignition power supply exceeding the withstanding voltage between the gate and the source leads to breakage of the MOSFET 123 in most cases.

### <Effects and Advantages of Electric Oil Pump 1>

(1) The control substrate 101 of the electric oil pump 1 includes: the substrate 102; the positive terminal 120a and the GND terminal 120d, to which a DC ignition power supply is input; and the reverse connection protection circuit 103. The reverse connection protection circuit 103 includes the MOSFET 123 and protects circuits in the substrate 102 in a case in which positive and negative connection of the ignition power supply is reversed. The control substrate 101 includes the first substrate wiring 127 that is connected to the source 123b of the MOSFET 123, the second substrate wiring 124 that is connected to the GND terminal 120d, and the bypass circuit 115. The bypass circuit 115 causes a current to flow from the first substrate wiring 127 toward the second substrate wiring 124 in a case in which the output voltage of the external power supply is equal to or greater than the bypass opening value. The bypass opening value (=16 [V]) is a value that is smaller than the withstanding voltage (20 [V]) between the gate and the source of the MOSFET 123.

In such a configuration, it is assumed that the output voltage from the ignition power supply starts to become greater than 12 [V], which is the rated voltage, in a state in which positive and negative sides of the ignition power supply are appropriately connected. Then, the output voltage from the ignition power supply reaches 16 [V], which is the bypass opening value, before reaching 20 [V], which is the withstanding voltage between the gate and the source of the MOSFET 123. Then, the voltage between the gate and the source of the MOSFET 123 is maintained to be less than 20 [V] (less than the withstanding voltage) by the bypass circuit 115 causing a current to flow from the side of the source terminal 123b of the MOSFET 123 toward the side of the GND terminal 120d of the substrate 102. The bypass circuit 115 can be configured of an inexpensive electronic element such as a Zener diode 115a. Therefore, according to the electric oil pump 1, it is possible to prevent breakage of the MOSFET 123 due to an overvoltage at lower costs as compared with a case in which a high withstanding voltage (equal to or greater than a double the rated voltage of the external power supply, for example) MOSFET 123 is used.

(2) The substrate 102 includes the third substrate wiring 118 that is connected to the gate terminal 123c. The bypass circuit 115 includes a Zener diode 115a and a resistance element 115b that are electrically interposed between the first substrate wiring 127 and the second substrate wiring 124 and are connected to each other in series. The Zener diode 115a is electrically interposed between the first substrate wiring 127 and the third substrate wiring 118. The resistance element 115b is electrically interposed between the third substrate wiring 118 and the second substrate wiring 124. A Zener voltage of the Zener diode 115a is lower than the withstanding voltage (20 [V]) between the gate and the source of the MOSFET 123.

In such a configuration, the Zener voltage of the Zener diode 115a is the bypass opening value. In other words, the bypass opening value is 16 [V] since the Zener voltage is 16 [V] in the aforementioned example. The output voltage from the ignition power supply starts to become higher than 12 [V], which is the rated voltage, and then reaches the Zener voltage of the Zener diode 115a without reaching the withstanding voltage (20 [V]) between the gate and the source. Then, an avalanche breakdown occurs in the Zener diode 115a, and a current flowing from the first substrate wiring 127 to the GND through the bypass circuit 115 is generated. Then, the voltage between the gate and the source of the MOSFET 123 is maintained to be less than the withstanding voltage (20 [V]) between the gate and the source. Therefore, according to the electric oil pump 1, it is possible to prevent breakage of the MOSFET 123 at lower costs as compared with a case in which a high withstanding voltage MOSFET is used, using the bypass circuit 115 provided with the Zener diode 115a and the resistance element 115b.

Also, if the output voltage from the ignition power supply is equal to or greater than the bypass opening value (16 [V]), a voltage that is equal to or greater than the Zener voltage (16 [V]) is applied to the Zener diode 115a of the bypass circuit 115, and a current flows through the bypass circuit 115 in the electric oil pump 1. The voltage to be applied to the Zener diode 115a is stably maintained to be equal to or greater than the Zener voltage (16 [V]) by the aforementioned current being reduced to a small value to some extent by the resistance element 115b of the bypass circuit 115. Therefore, according to the electric oil pump 1, the following advantages can be achieved under a condition that the output voltage from the ignition power supply is equal to or greater than the bypass opening value (16 [V]). In other words, according to the electric oil pump 1, it is possible to stably apply a voltage that is equal to or greater than the Zener voltage (16 [V]) to the Zener diode 115a and to stably cause a current to flow through the bypass circuit 115.

Also, the bypass circuit 115 provided with the Zener diode 115a and the resistance element 115b reduces an installation space of the bypass circuit 115 on the substrate 102 in the electric pump 1 as compared with a bypass circuit provided with a varistor and a resistance element. Therefore, according to the electric oil pump 1, it is possible to reduce the size of the control substrate 101 as compared with a case in which the bypass circuit provided with the varistor and the resistance element is used. According to the control substrate 101 provided with the motor drive circuit 105, in particular, it is possible to effectively reduce the size of the control substrate 101 for the reason described below. In other words, in the control substrate 101 that drives the motor, the choke coil 108 that prevents an overcurrent and the MOSFET 123 are typically mounted between a large-sized first capacitor 104 that absorbs a ripple current and the power supply input unit 120 as illustrated in FIG. 7. With such a configuration, a slight vacant space is generated in a circumference of the MOSFET 123 with a smaller plane size than that of the choke coil 108. It is possible to dispose the bypass circuit 115 provided with the Zener diode 115a and the resistance element 115b in the aforementioned vacant space and thereby to effectively reduce the size of the control substrate 101.

(3) The control substrate 101 includes the first test point 116 that has electrical continuity to the first substrate wiring 127 and the second test point 117 that has electrical continuity to the third substrate wiring 118.

According to the electric oil pump 1 with such a configuration, bringing a probe of an inspection device into contact with the first test point 116 and the second test point 117 enables the following matters. In other words, it is possible to inspect whether or not there is an electric connection failure between the Zener diode 115a and the substrate wirings, and it is possible to inspect electric properties of the Zener diode 115a in the bypass circuit 115. Alternatively, it is possible to inspect whether or not there is an electric connection failure between a varistor 115c in a modification example, which will be described later, and the substrate wiring, and it is possible to inspect electric properties of the varistor 115c in the bypass circuit 115.

Also, according to the electric oil pump 1, bringing the probe of the inspection device into contact with the second test point 117 and the GND terminal 120d enables the following matters. In other words, it is possible to inspect whether or not there is an electric connection failure between the resistance element 115b and the substrate wiring, and it is possible to inspect electric properties of the resistance element 115b in the bypass circuit 115.

Also, according to the electric oil pump 1, it is possible to inspect electric properties of the bypass circuit 115 by bringing the probe of the inspection device into contact with the first test point 116 and the GND terminal 120d.

Note that the first test point 116 and the second test point 117 are circular electrodes disposed on the first surface of the substrate 102 as illustrated in FIG. 7. The shape of the electrodes of the test points is not limited to the circular shape and may be, for example, a ring shape, a long circular shape, a square shape, a rectangular shape, or the like.

(4) The control substrate 101 includes the first capacitor 104 that is formed of an electrolytic capacitor and the motor drive circuit 105. The first capacitor 104 is electrically interposed between either the first substrate wiring 127 or the fourth substrate wiring 129 that is connected to the first substrate wiring 127 on a side downstream of the first substrate wiring 127 via the electronic element (for example, the choke coil 108) and the second substrate wiring 124. The motor drive circuit 105 is disposed on a side downstream of the first capacitor 104.

According to the electric oil pump 1 with such a configuration, the motor drive circuit 105 can drive the motor 11 at a stable rotation speed by the first capacitor 104 absorbing the ripple current from the ignition power supply using a charging function.

(5) The electric oil pump 1 includes the pump unit 40, the motor unit 10 that drives the pump unit 40, and the control substrate 101. The control substrate 101 includes the motor drive circuit 105 that drives the motor 11 of the motor unit 10.

According to the electric oil pump 1 with such a configuration, it is possible to drive the motor 11 of the motor unit 10 with the control substrate 101 at low costs that does not use a high withstanding voltage MOSFET for the bypass circuit 115.

### MODIFICATION EXAMPLE

Next, a modification example in which a part of the configuration of the electric oil pump 1 according to the example embodiment is changed to another configuration will be described. Note that the configuration of the electric oil pump 1 according to the modification example is similar to that in the example embodiment unless particularly indicated below otherwise.

FIG. 10 is a circuit diagram illustrating a part of circuits on the control substrate 101 of the electric oil pump 1 according to the modification example. The bypass circuit 115 of the control substrate 101 illustrated in the drawing includes the varistor 115c instead of the Zener diode in the example embodiment. The varistor 115c is interposed between the first substrate wiring 127 and the third substrate wiring 118.

In a case in which a voltage applied between two lead lines of the varistor 115c is less than a varistor voltage unique to the varistor 115c, the varistor 115c does not cause a current to flow therethrough. Meanwhile, in a case in which the voltage applied between the two lead lines is equal to or greater than the varistor voltage, the varistor 115c causes a current to flow therethrough. In the electric oil pump 1 according to the modification example, the varistor voltage is, for example, 16 [V].

### <Effects and Advantages of Electric Oil Pump 1 According to Modification Example>

(6) The substrate 102 includes the third substrate wiring 118 that is connected to the gate terminal 123c. The bypass circuit 115 includes the varistor 115c and the resistance element 115b that are electrically interposed between the first substrate wiring 127 and the second substrate wiring 124 and are connected to each other in series. The varistor 115c is electrically interposed between the first substrate wiring 127 and the third substrate wiring 118. The resistance element 115b is electrically interposed between the third substrate wiring 118 and the second substrate wiring 124. The varistor voltage of the varistor 115c is lower than the withstanding voltage (20 [V]) between the gate and the source of the MOSFET 123.

In such a configuration, the varistor voltage of the varistor 115c is the bypass opening value. In other words, the bypass opening value is 16 [V] since the varistor voltage is 16 [V] in the aforementioned example. The output voltage from the ignition power supply starts to become higher than the rated voltage 12 [V] and then reaches the varistor voltage of the varistor 115c without reaching the withstanding voltage (20 [V]) between the gate and the source. Then, a current flowing from the first substrate wiring 127 to the GND through the bypass circuit 115 is generated. Then, the voltage between the gate and the source of the MOSFET 123 is maintained to be less than the withstanding voltage (20 [V]) between the gate and the source. Therefore, according to the electric oil pump 1, it is possible to prevent breakage of the MOSFET 123 at lower costs as compared with a case in which a high withstanding voltage MOSFET is used, using the bypass circuit 115 provided with the varistor 115c and the resistance element 115b.

Also, if the output voltage from the ignition power supply is equal to or greater than the bypass opening value (16 [V]), a voltage that is equal to or greater than the varistor voltage (16 [V]) is applied to the varistor 115c of the bypass circuit 115, and a current flows through the bypass circuit 115, in the electric oil pump 1. The voltage applied to the varistor 115c is stably maintained to be equal to or greater than the varistor voltage (16 [V]) by the aforementioned current being reduced to a small value to some extent with the resistance element 115b of the bypass circuit 115. Therefore, according to the electric oil pump 1, the following advantages can be achieved under a condition that the output voltage from the ignition power supply is equal to or greater than the bypass opening value (16 [V]). In other words, according to the electric oil pump 1, it is possible to stably apply the voltage that is equal to or greater than the varistor voltage (16 [V]) to the varistor 115c and to cause a current to stably flow through the bypass circuit 115.

In addition, the bypass circuit provided with the varistor 115c and the resistance element in the electric oil pump 1 enables the following matters as compared with a bypass circuit provided with the Zener diode and the resistance element. In other words, the electric oil pump 1 enables absorption of a surge with a higher amplification as a surge of the output voltage of the ignition power supply caused by inductance. Therefore, according to the electric oil pump 1, it is possible to curb breakage of the MOSFET 123 due to the surge as compared with a configuration using a bypass circuit provided with the Zener diode and the resistance element.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A circuit substrate comprising:
a substrate;
a positive terminal and a GND terminal to which a DC external power supply is input;
a reverse connection protection circuit that includes a MOSFET and protects a circuit in the substrate in a case in which positive and negative connection of the external power supply to the positive terminal and the GND terminal is reversed;
a first substrate wiring that is connected to a source terminal of the MOSFET;
a second substrate wiring that is connected to the GND terminal; and
a bypass circuit that causes a current to flow from the first substrate wiring to the second substrate wiring in a case in which an output voltage of the external power supply is equal to or greater than a predetermined value; wherein
the predetermined value is smaller than a withstand voltage between a gate and the source of the MOSFET.

2. The circuit substrate according to claim 1, further comprising:
a third substrate wiring that is connected to the gate terminal of the MOSFET; wherein
the bypass circuit includes a Zener diode and a resistor electrically interposed between the first substrate wiring and the second substrate wiring and connected to each other in series;
the Zener diode is electrically interposed between the first substrate wiring and the third substrate wiring;
the resistor is electrically interposed between the third substrate wiring and the second substrate wiring; and
a Zener voltage of the Zener diode is lower than the withstand voltage between the gate and the source of the MOSFET.

3. The circuit substrate according to claim 1, further comprising:
a third substrate wiring that is connected to the gate terminal of the MOSFET; wherein
the bypass circuit includes a varistor and a resistor electrically interposed between the first substrate wiring and the second substrate wiring and are connected to each other in series;
the varistor is electrically interposed between the first substrate wiring and the third substrate wiring;
the resistor is electrically interposed between the third substrate wiring and the second substrate wiring; and
a varistor voltage of the varistor is lower than the withstand voltage between the gate and the source of the MOSFET.

4. The circuit substrate according to claim 2, further comprising:
a first test point that has electrical continuity with the first substrate wiring; and
a second test point that has electrical continuity with the third substrate wiring.

5. The circuit substrate according to claim 3, further comprising:
a first test point that has electrical continuity with the first substrate wiring; and
a second test point that has electrical continuity with the third substrate wiring.

6. The circuit substrate according to claim 2, further comprising:
an electrolytic capacitor; and
a motor drive circuit; wherein
the electrolytic capacitor is electrically interposed between either of the first substrate wiring or a fourth substrate wiring that is connected to the first substrate wiring via an electronic element downstream of the first substrate wiring and the second substrate wiring; and
the motor drive circuit is disposed downstream of the electrolytic capacitor.

7. The circuit substrate according to claim 3, further comprising:
an electrolytic capacitor; and
a motor drive circuit; wherein
the electrolytic capacitor is electrically interposed between either of the first substrate wiring or a fourth substrate wiring that is connected to the first substrate wiring via an electronic element downstream of the first substrate wiring and the second substrate wiring; and
the motor drive circuit is disposed downstream of the electrolytic capacitor.

8. The circuit substrate according to claim 4, further comprising:
an electrolytic capacitor; and
a motor drive circuit; wherein
the electrolytic capacitor is electrically interposed between either of the first substrate wiring or a fourth substrate wiring that is connected to the first substrate wiring via an electronic element downstream of the first substrate wiring and the second substrate wiring; and
the motor drive circuit is disposed downstream of the electrolytic capacitor.

9. An electric oil pump comprising:
a pump;
a motor that drives the pump; and
a circuit substrate; wherein
the circuit substrate includes a motor drive circuit that drives the motor unit; and
the circuit substrate is the circuit substrate according to claim 6.
